(19) United States
(12) Patent Application Publication
(10) Pub. No.: US 2026/0092850 A1
(43) Pub. Date: Apr. 2, 2026

(54) Automated High Throughput Protorheology

(71) Applicant: The Board of Trustees of the University of Illinois, Urbana, IL (US)

(72) Inventors: Randy Ewoldt, Savoy, IL (US); Sameh Tawfick, Champaign, IL (US); Ignacio Arretche, Champaign, IL (US); Nancy R. Sottos, Champaign, IL (US); Jeffrey S. Moore, Savoy, IL (US); Phillippe Geubelle, Champaign, IL (US); Mohammed Tanver Hossain, Urbana, IL (US); Connor Armstrong, Urbana, IL (US); Jacob J. Lessard, North Salt Lake, UT (US); Ramdas Tiwari, Urbana, IL (US); Michael Zakoworotny, Urbana, IL (US)

(21) Appl. No.: 19/347,242

(22) Filed: Oct. 1, 2025

Related U.S. Application Data
(60) Provisional application No. 63/701,973, filed on Oct. 1, 2024.

(51) Int. Cl. G01N 11/00; G06N 3/0464

(52) U.S. Cl. CPC G01N 11/00; G06N 3/0464; G01N 2011/008

(57) ABSTRACT

This disclosure generally relates to rheological property measurements/estimation for fluidic materials and is specifically directed to methods and systems for automatic and high-throughput estimation of rheological properties via videography of visually observable tests and neural-network processing. The high throughput may be achieved via parallel testing. The disclosed methods and systems provide an economical approach to estimating rheological properties with reasonable prediction accuracy based on visual observables without relying on expensive and complex rheometric setup and equipment.

### CROSS REFERENCE

This application is based on and claims the benefit of priority to U.S. Provisional Application No. 63/701,973, filed on Oct. 1, 2024, which is herein incorporated by reference in its entirety.

### GOVERNMENT SUPPORT

This invention was made with government support under DE-SC0023457 awarded by US Department of Energy. The government has certain rights in the invention.

### BACKGROUND

### Technical Field

This disclosure generally relates to rheological property measurements for fluidic or solid materials and is specifically directed to methods and systems for automatic high-throughput estimation of rheological properties via videography of visually observable tests and neural-network processing.

### Background Technologies

Rheological properties are critical aspects of fluidic or solid-state materials. Examples of rheological properties include viscosity, yield stress, and the like. Measurements of such rheological properties, for example, may be obtained using slow, complex and expensive equipment. Such equipment is also challenging to automate. For example, typical viscometers and rheometers may require precise sensors and machined parts, making them economically inaccessible in many application scenarios, particular in situations when only a rheological estimate (such as upper and/or lower bound) is needed.

### BRIEF SUMMARY

This disclosure generally relates to rheological property measurements for fluidic or solid-state materials and is specifically directed to methods and systems for automatic and high-throughput estimation of rheological properties via videography of visually observable tests and neural-network processing. Such high throughput may be achieved via parallel testing. The disclosed methods and systems provide an economical approach to estimate rheological properties with reasonable prediction accuracy based on visual observables without relying on expensive and complex rheometric setup and equipment.

In some example implementations, a method for generating an estimate of at least one rheological property of a plurality of fluids or solid-state materials is disclosed. The method may include providing a plurality of carriers; loading the plurality of fluids or solid-state materials into or on the plurality of carriers; setting the plurality of fluids or solid-state materials in motions relative to the plurality of carriers so as to commence a plurality of visually observable rheological tests of the plurality of fluids or solid-state materials; synchronously triggering a recording of digital videos of the plurality of visually observable rheological tests for the plurality of fluids or solid-state materials during the motions; and automatically generating the estimate of the at least one rheological property for the plurality of fluid or solid-state material by propagating the digital videos through a pretrained multilayer neural network model.

In some other example implementations, a system for generating an estimate of at least one rheological property of a plurality of fluids or solid-state materials is disclosed. The system may include, comprising a platform; a plurality of testing stations configured on the platform for securing a plurality of carriers for loading the plurality of fluids or solid-state materials; a plurality of driving mechanisms for setting the plurality of fluids or solid-state materials in motions relative to the plurality of carriers so as to commence a plurality of visually observable rheological tests of the plurality of fluids or solid-state materials; a video camera; and a controller configured to control the video camera to synchronously trigger a recording of digital videos of the plurality of visually observable rheological tests for the plurality of fluids or solid-state materials during the motions and to automatically generate the estimate of the at least one rheological property for the plurality of fluids or solid-state materials by propagating the digital videos through a pretrained multilayer neural network model.

For a specific example, the disclosure provides a mechanical setup that consists of a series of closed vials filled with fluids or solid-state materials as test samples. The system includes mechanical drivers (such as stepper motor(s)) and controllers that are configured to simultaneously flip/tilt/turn the series of closed vials. As the vials turn, the controller is configured to trigger a camera to record the fluids or solid-state materials flow and settlement in the vials. The recorded video is then processed and fed as input to a machine-learning model that estimates the viscosity of the fluids or solid-state materials from this video. The machine learning model, for example, may include a 2-dimensional convolutional neural network, a bidirectional long-short-term memory recurrent neural network, and attention network layer(s). The machine learning model may be pre-trained using labeled standard calibration fluids or solid-state materials typically used for calibrating rheometers and viscometers.

The example implementations summarized above and described in further detail bellow provide economically viable methods and systems capable of estimating rheological properties such as viscosity by controlling a camera to capture videos of visually observable and non-contact tests in an automatic and intelligent manner and with high throughput.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows example visually observable tests for protorheology.

FIG. 2 illustrates an example deep learning model for estimating rheological properties of fluids or solid-state materials using video images of visually observable tests.

FIG. 3 illustrates a general example of an automated and high throughput protorheology system.

FIG. 4 illustrates a specific example of an automated and high throughput protorheology system.

FIG. 5A and FIG. 5B illustrate an example deep learning model for estimating rheological properties from images of visually observable tests.

FIG. 6 and FIG. 7 illustrate example image preprocessing for generating region of interest images.

FIG. 8 illustrates time sequence of region of interest images of several different fluids in a vial flipping test.

FIG. 9 shows an example usage of labeled image data for training and testing purposes for the deep learning model for protorheology.

FIG. 10 shows another example usage of labeled image data for training and testing purposes for the deep learning model for protorheology.

FIG. 11 and FIG. 12 illustrates performance evaluations of a trained deep learning model for protorheology.

FIGS. 13A-13D illustrates prediction of rheological properties using a trained deep leaning model for liquids that are Newtonian at low shear stress but non-Newtonian at high shear stress.

### DETAILED DESCRIPTION

Various aspects for an automated intelligent high-throughput protorheology will now be described in detail hereinafter with reference to the accompanied drawings, which form a part of the present disclosure, and which show, by way of illustration, various example implementations and embodiments. The imaging processing and robotic navigational devices and systems disclosed herein may, however, be embodied in a variety of different forms and, therefore, the disclosure herein is intended to be construed as not being limited to the embodiments set forth below. Further, the disclosure may be embodied as methods, components, and/or platforms in addition to the disclosed devices and systems. Accordingly, embodiments of the disclosure may, for example, take the form of hardware, software, firmware or any combination thereof.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Many other modifications of the implementations above may be made to adapt a particular situation or material to the teachings without departing from the scope of the current disclosure. Therefore, it is intended that the present methods and systems not be limited to the particular embodiments disclosed, but that the disclosed methods and systems include all embodiments falling within the scope of the appended claims.

### Rheology

By ways of introduction, various fluidic materials, referred to as fluids, and some solid-state materials are associated with a set of rheological properties or characterizations. The term fluids as used herein refers to a broad range of materials that exhibit, for example, finite viscosity, and that flow at various time scales. Some materials may exhibit solid state-like characteristics, while still being fluids, with vary large viscosity, and slowly flowing, e.g., pitch (a tar derivative). Measurements and determination of rheological properties of fluids or solid-state materials are critical for material characterization that provides basic information for various engineering and industrial designs and applications involving these fluids or solid-state materials.

Rheological properties, for example, may include but are not limited to viscosity, yield stress, thixotropy, viscoelasticity, shear normal stress differences, extensional viscosity, and the like. For some solid-state materials, rheological properties may include but are not limited to elastic modulus, loss tangent, or other viscoelastic properties, or the like. The rheological properties for either fluids or solid-state materials may be alternatively referred to as rheological phenomena or rheological characteristics.

Accurate measurements and determination of such rheological properties of a fluid or a solid-state material may involve a set of complex and expensive measurement equipment that may not be readily accessible and difficult to maintain. Sample preparation for such measurements may be time-consuming, cumbersomely elaborate, and may not be contact-free. Examples of rheological instruments may include but are not limited to rheometers, viscometers, and the like, which usually includes various advanced sensing components for detecting signals and information that are beyond the capability of human visual perception.

### Protorheology

In some applications of fluids or solid-state materials, however, precision measurement of the rheological properties of these fluids or solid-state materials may not be necessary. Instead, an estimation of the rheological properties may be sufficient. For example, it may be only necessary, in some situations, to know a value range in which a rheological property falls. Estimation rather than precise measurements of rheological properties may be referred to as protorheology, where the Latin root of “Proto” refers to “first”, as in the words of “prototype” and “protohuman”. The term protorheology may thus be used to generally refer to initial estimation of rheological properties of fluid or solid-state material. Protorheology may be faster, much more convenient, and much less expensive to obtain. A protorheological measurement may only serve as an approximation and may not be accurate, but it may nevertheless be sufficient for providing guidance to various design and engineering decisions.

For example, protorheology of a fluid or solid-state material may be based on visual observations of behaviors of the fluid or solid-state material. Such observation may be made under scooping, bouncing, dripping and other mechanical actions/manipulations of the fluid or solid-state material. The visual observables may include dynamical response of the fluid or solid-state material in shape, motion, vibration, and other visual aspects when the fluid or solid-state material is being acted upon or is settling after being set in an initially non-steady state.

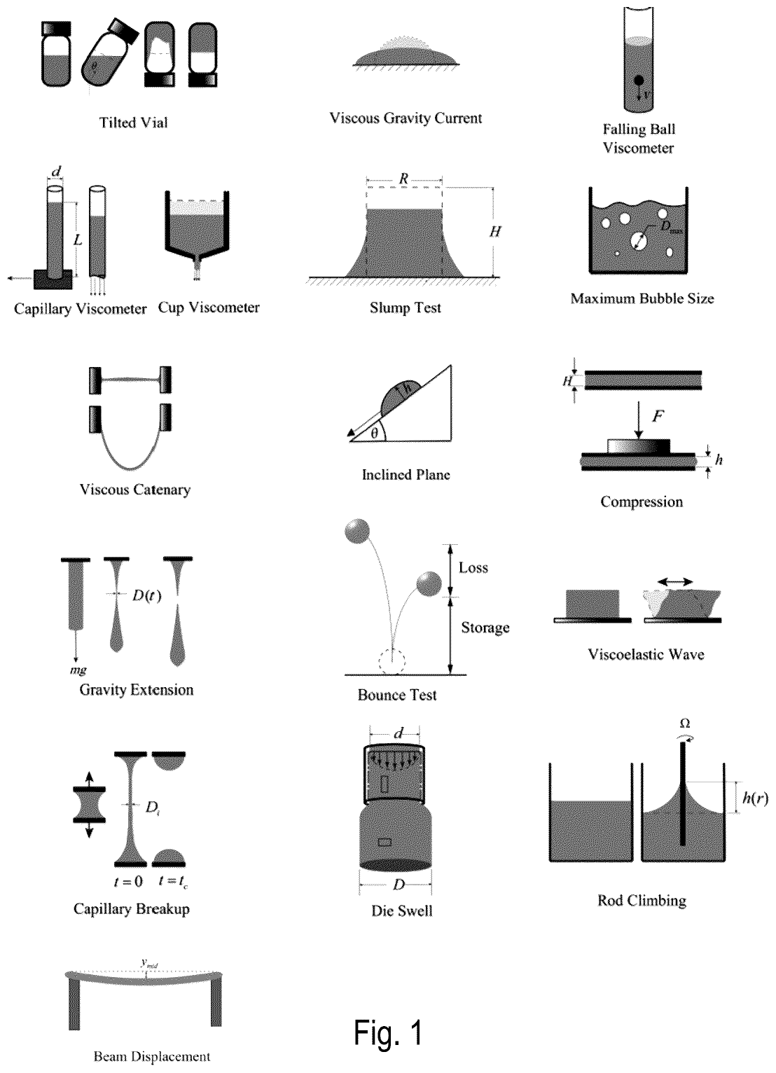

A protorheological measurement thus may involve a visually observable test for a fluid or solid-state material's reaction to, e.g., mechanical disturbances, and extracting visual information from the test in order to generate estimates of one or more rheological properties. Example visually observable tests for protorheological measurements are illustrated in FIG. 1, including:
Tilted vial test, where a capped vial or other types of transparent container partially filed with the fluid is tiled or flipped, followed by observing the flow or motion of the fluid. The tilted vial test (the flip-vial test in particular) may use cylindrical, spherical, triangular prism, or cuboid vial geometries;
Viscous gravity current test, where a fluid puddle's spreading on a flat surface under gravity is observed;
Falling ball viscometric test, where a solid ball is allowed to drop through a fluid while being observed;
Capillary viscometric test, where observation is made when a fluid is allowed to flow through a tube (capillary), as caused by, for example, the force of gravity;
Cup viscometric test, where observation is made when a fluid flows by gravity out of a reservoir, e.g. out of an opening at the bottom with a diameter that is smaller than the diameter of the reservoir;
Slump test, where observation is made when a material is placed on a surface and spreads (slumps) under gravity, and may stop flowing and retain part of its original shape due to being a shear-thinning yield-stress fluid;
Maximum bubble size test, where the maximum size of air bubbles present in a fluid is visually observable and an indication of a critical material stress for nonlinear flow properties;
Viscous catenary test, where shape of catenary beam of a fluid may be observed;
Inclined plane test, where shape/geometry and flow speed of a fluid puddle on an inclined surface may be observed;
Compression test, where deformation of a fluid or solid-state material under compression may be observed;
Gravity extension test or breakup test, where fluid or solid-state material extension and breakage under gravity may be observed;
Bounce test, where energy loss and energy storage of a bouncing material may be observable;
Viscoelastic wave test, where the natural vibrational frequency and elastic wave speed of fluids or solid-state materials may be observed;
Capillary driven/breakup test, where fluid extension and breakage under capillary squeezing (surface tension pinching) may be observed;
Die swell test, where the diameter of an extruded material may be observed, which may be larger than the internal diameter of the die opening;
Rod climbing test, where height changes of a liquid due to rotation of a central rod may be observed;
Beam displacement test, where a viscoelastic beam of fluids or solid-state materials sagging under gravity may be observed.

In each of these tests above, the fluid or solid-state material may be initially configured in a first predefined state and then is set to react (e.g., to flow, settle, move, shake, vibrate, reshape, distort, rotate and the like, or any combination thereof) to impulse or continuous external stimuli (e.g., gravity, compression, impact, surface tension, or the combination there of). Such reaction of the fluid or solid-state material may be visually observable. Such observed reaction may be dependent on and thus may be used to derive or at least approximate one or more rheological properties of the fluid or solid-state material.

For example, the viscous gravity current test, the tilted vial test, the viscous catenary test, the capillary viscometric test, the cup viscometric test, the falling ball viscometric test, and the incline plane test of FIG. 1 may be closely related to and thus provide a convenient protorheological estimation of the viscosity of the fluid, and if different conditions are used, may be used to estimate shear-thinning or shear-thickening properties of the fluid or solid-state material.

For another example, the inclined plane test, the maximum bubble size test, the slump test, the compression test, the gravity extension test, and tilted vial test may be observed to estimate a yield stress for a yield-stress fluid (a yield stress fluid represents a type of material which behaves like a fluid yet behaves like a solid below its yield stress).

For another example, the bounce test, the compression test, the inclined plane test, the viscoelastic wave test, and a beam displacement test may be observed for protorheological estimation of viscoelastic properties of the fluids or solid-state materials.

For another example, the die swell test, the rod climbing test, the gravity driven or gravity breakup test, and the capillary driven/breakup test may be observed to for protorheological estimation of shear normal stress differences of the fluid or solid-state material.

For another example, the gravity-driven extension test and the capillary driven/breakup test may be observed for protorheological estimation of extensional viscosity of the fluid or solid-state material.

As such, each of the example visually observable tests above may be a full or partial indicator of one or more rheological properties. A combination of the several observable tests may be considered a full or partial indicator of one or more rheological properties. A particular rheological property may affect one of more of the visually observable tests. Likewise, a particular visually observable test may be affected by one or more of the rheological properties, as shown above by the various correlations between the rheological properties and the example visually observable tests of FIG. 1.

The visual observation of each of these tests may be quantifiable. For example, a settlement time of the fluid after a vial flip may be observed and quantified. For another example, the maximum size of bubbles in a maximum bubble test of FIG. 1 may be observed and quantified. For another example, a steady-state radius and height of a puddle of the fluid in the inclined plane test and slump test of FIG. 1 may be observed and quantified. For another example, a breaking time in the gravity extension test and the capillary breakup test shown in FIG. 1 may also be observed and quantified. For another example, loss and storage heights of a fluid droplet in a bounce test of FIG. 1 may be observed and quantified. For another example, a fluid film height under the compression test of FIG. 1 may be observed and quantified. For another example, a wave oscillation frequency of the viscoelastic wave test of FIG. 1 may be observed and quantified. For another example, an amount of beam displacement in the beam displacement test of FIG. 1 may be observed and quantified. For yet another example, a climbing height of a rotating fluid up a center rod in the rod climbing test may be observed and quantified.

The quantification of the observed fluid or solid-state material reaction, as described above, alone or in combination, may form a basis for protorheological estimation. In some implementations, analytical or numerical relationship between these quantifications and the rheological properties of the fluid or solid-state material may be identified, approximated, or modeled. Such relationship may provide a rule-based and deterministic derivation and quantification from observed reactions in these visually observable tests above to obtain rheological property estimation. However, because of the complex and sometimes not-so-well defined relationship or derivation/quantification process between these observed reactions and the rheological properties, such rule-based and deterministic estimation may not always be readily obtainable.

Further detailed disclosure of the various example visually observable tests above, their quantifications, and modeling of such quantifications in relation to the various rheological properties or rheological phenomena are provided in the Appendix attached to the related provisional application.

In some example implementations, the visually observable tests and reactions of the fluid or solid-state materials above may be recorded as digital images. Such digital images thus form a time sequence of for a particular test. The fluid or solid-state material reaction in each particular test thus may be recorded as function of time. Both static observation information from the images (e.g., fluid shape, size, inclination, spread, and the like) and time evolution information (e. g., flow, settlement, shaking, vibration, reshaping, distortion, rotation, and the like) of the fluid or solid-state material reaction in these tests may also provide valuable observable information for the estimation of the rheological properties.

As described in further detail below, these images may undergo analytics by trained machine learning or artificial intelligence models to yield the various rheological properties. While the disclosure below may apparently differentiate fluids and solid-state materials in some places for some types of visually observable tests, the disclosed implementations for protorheology based on processing visually observable tests using neural network or other machine learning models are generally applicable to both fluidic and solid-state materials and for estimating any type of rheological properties.

### Protorheology Based on Machine Learning

In some implementations, rather than analytical or stimulatory derivation of rheological properties from the static of video images taken from the visually observable tests above, estimation of rheological properties may instead be obtained via machine learning models, particularly via pre-trained deep learning models.

For example, a deep learning model including multi-layer neural networks may be pre-trained and used to process a sequence of images taken from one or more visually observable tests above for a fluid or solid-state material. The deep learning model may be configured to output an estimate of a particular rheological property of the fluid or solid-state material or a set of rheological properties. Such output may be provided as estimated values, or as estimated ranges for the rheological properties. Such a deep learning model thus may include a sufficient number of model parameters that are trained to identify various features and patterns in the input images for estimating the rheological properties.

In some example implementations, the input images or sequence of input images may be pre-processed, for example, to remove color information (as color information usually non-mechanical and thus plays little role in rheological property estimation). Further, as described in further detail below, the raw images or sequence of images may be cropped in various manners before being provided to the deep leaning model for processing a region of interest (ROI) in the images.

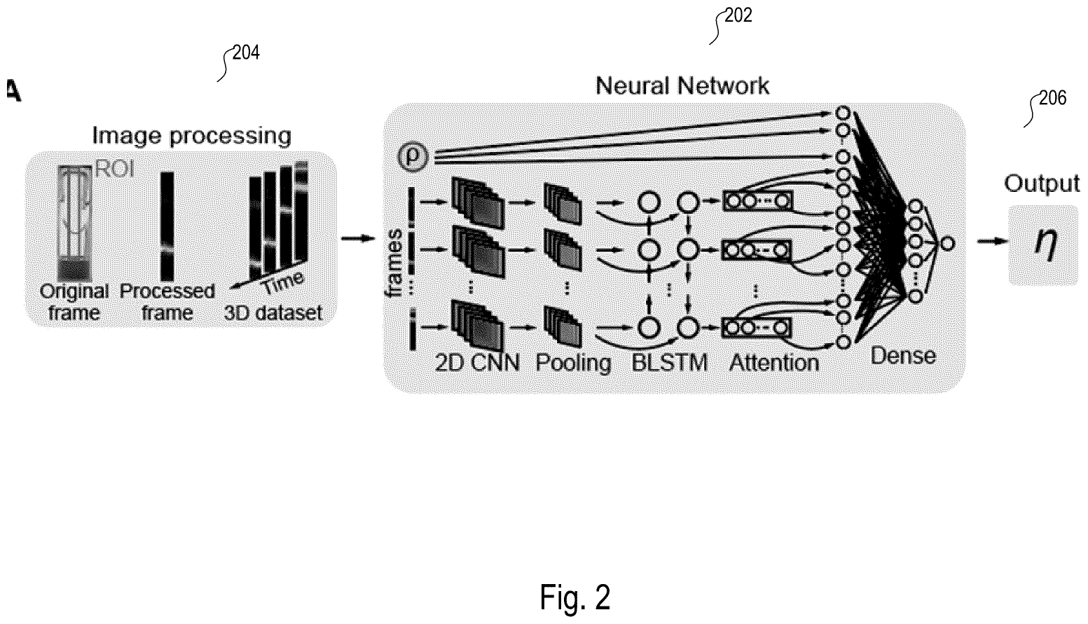

As shown in FIG. 2, a deep learning model 202 for estimating rheological properties, for example, may include a 2-dimensional neural network (e.g., convolutional neural network (CNN)), a recurrent neural network, and an attention network for processing the input video 204 (e.g., after preprocessing) to generate a measure 206 of the rheological property. The recurrent neural network, for example, may include a bidirectional long-short-term memory (LSTM) recurrent neural network (RNN). The deep learning model may further include other network layers such as pooling layers and dense or fully connect network layer(s) between the attention network and the output 206. Particular example deep learning models and training of such models are provided in further detail below.

### Automated Intelligent High-Throughput Protorheology

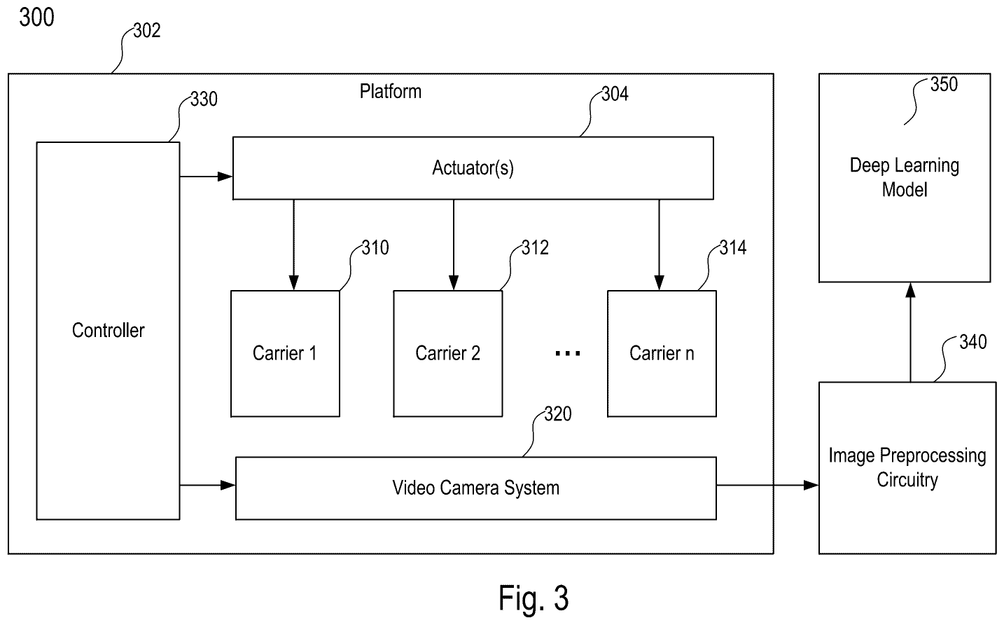

In some example implementations, the processes above involving performing the various visually observable tests and machine learning as described above may be automated to achieve high throughput protorheology. An example system is illustrated in FIG. 3.

The example system 300 of FIG. 3 includes a platform 302 for hosting a plurality of carriers or holders 310 through 314 for sample fluids or solid-state materials, one or more actuators 304 for setting the carriers into desired visually observable tests, a video camera system 320 (including imaging and optical components) for capturing and recording the fluid or solid-state material reactions in the carriers during the visually observable tests. The system 300 may further include a controller 330 configured to control the actuator 304 and the carriers 310 through 314 for setting up and performing the visually observable tests and for controlling a timing of the operation of the video camera system so that the video capturing and recording is synchronized or otherwise properly timed with the visually observable tests. For example, the visually observable test may be of an impulse type of action of the carriers (e.g., sudden tilting of vials) followed by a reaction of the fluid or solid-state material therein. In such situations, the operation of the camera may be triggered by the impulse.

The system 300 may further include an image preprocessing circuitry 340 (including general purpose or dedicated hardware or software components) for preparing the recorded video/images for analysis by the deep learning model 350.

The controller 330 and the image preprocessing circuitry 340 may be achieved via a general-purpose computer hardware including general purpose or specialized processors and memories and software/middleware/firmware running on the general-purpose computer hardware. Control interface may be configured to provide control signals to the video camera system 320 and the actuator 304.

The deep learning model may also be implemented within the general-purpose or dedicated hardware components described above. In some other implementations, depending on the computational intensity, the deep learning model may be hosted remotely by a computer system having sufficient computation power and memory space. In such situations, the system 300 may be further configured to communicate, via a network connection, the recorded video images to the remote computer system where the deep learning model is hosted. The remote computer system may receive the images, pre-process the images if needed, analyze the images using the deep learning model to generate protorheological estimation results, and further communicate the protorheological estimation results to the system 300 via the network connections. A neural network may be implemented in a variety of manners, including a multiple layer network running on a generic GPU, special neural network hardware, physically-informed neural networks, and the like.

The carriers 310 through 314 may be identical and may be configured to perform similar visually observable tests in parallel. The tests may be performed in parallel for the same fluid/solid-state material or different fluids/solid-state materials. As such, the actuators 304 may be shared. In other words, the carriers 310 through 314 may be driven to perform the same visually observable test by a single actuator. Alternatively, the carriers 310 and 414 may be connected to individual actuators. These actuators may be configured to perform different types of visually observable tests and may rely on different driving mechanisms. In such a manner, different tests may be performed in parallel, for a same fluid/solid-state material or for different fluids/solid-state materials. The actuator may operate under any suitable driving mechanism. For example, it may be a motor, an electromechanical device, an ultrasonic vibrator, a hydraulic device, and the like.

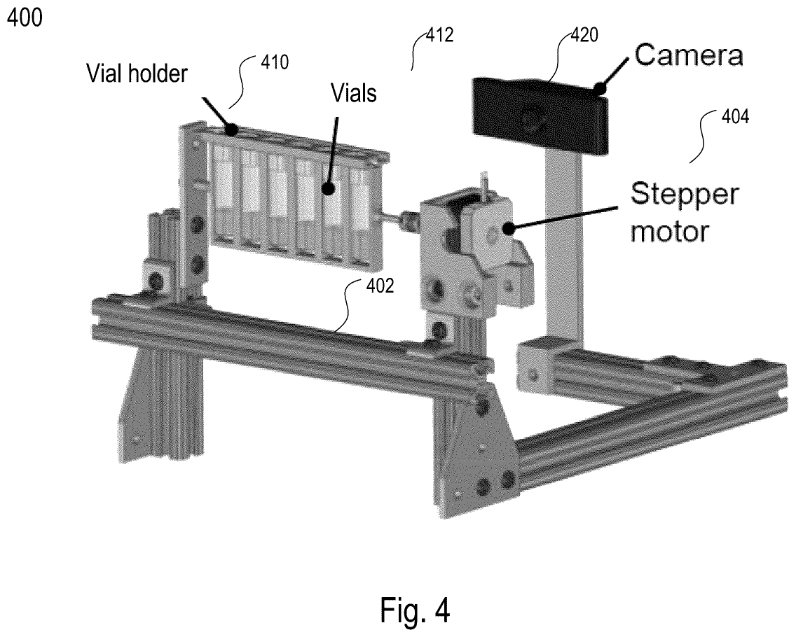

FIG. 4 further illustrates a specific example system for high throughput protorheology. The system 400 of FIG. 4 is configured for performing protorheology based on multiple vial tiling tests. In the system 400 of FIG. 4, the platform 402 may include a vial holder 410 that is capable of holding multiple vials 412, a stepper motor 404 that may be controlled to tilt the vials 412 in the vial holder 410 to a desired tilting angle with a desired rotational speed, and a video camera 420 that is controlled to capture and record video images of the vials 412. For simplicity, the controller and the computing subsystem for hosting the deep learning model are not shown in FIG. 4.

In some example implementations, the fluids or solid-state material may possess time varying behaviors due to a physical or chemical reaction which changes the rheological properties of the fluids or solid-state materials at, for example, ambient conditions, and a triggering of a recording of the digital video of the visually observable rheological tests and generating the rheological estimate may be repeated to capture the time varying behavior.

In some example implementations, a pretrained multi-layer neural network model above may further provide an estimate of an expected variation of the rheological property of the fluids or solid-state materials at durations longer than visually observable rheological tests

The protorheological system depicted in the examples of FIG. 3 and FIG. 4 provide several advantages. They are high-throughput in that multiple tests can be performed in parallel. They are also much more economical in comparison to rheometers and only require generic components and rely on visual observables that do not require specialized sensors to obtain. The measurement processes are largely automated and may be reconfigurable. Sample preparation and loading for the measurement and the cleaning process after the measurement are simplified.

### Example Deep Leaning Model and Training and Image Preprocessing

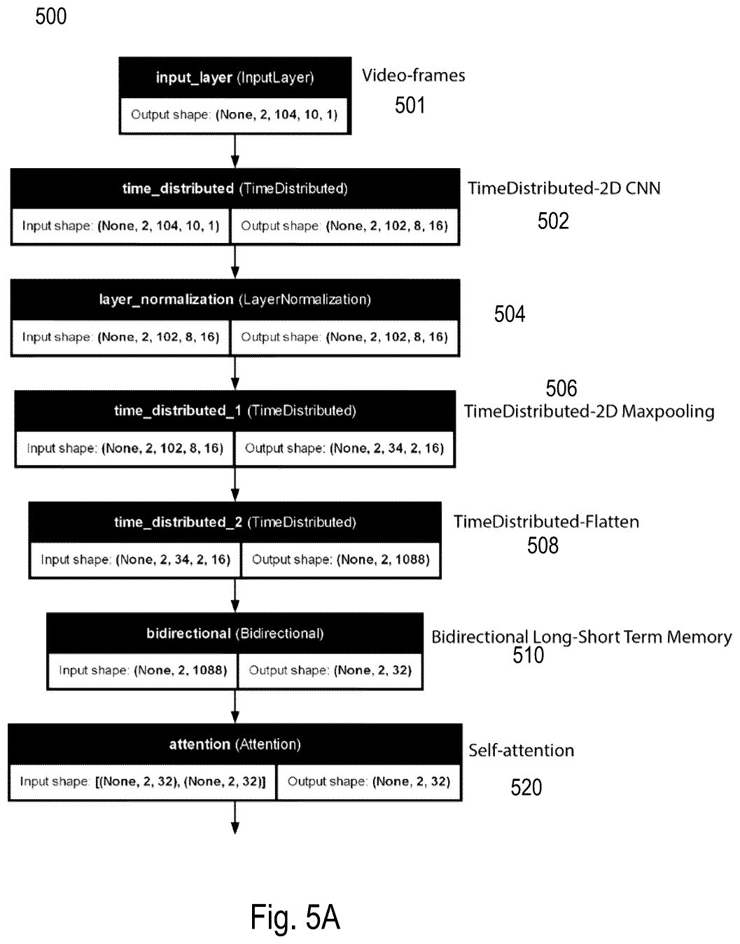

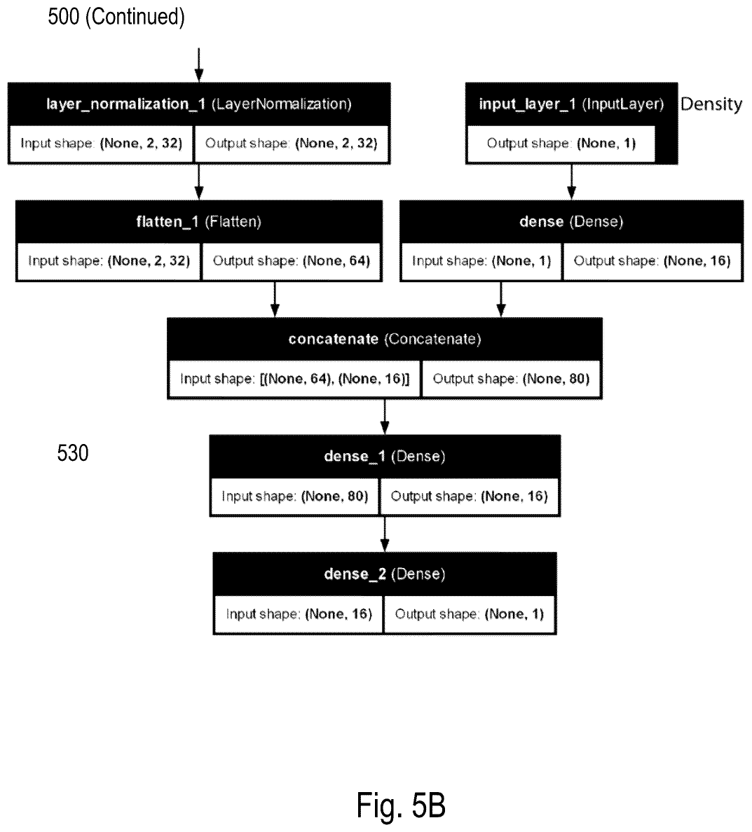

A specific example for the deep learning model above is illustrated in FIG. 5A and FIG. 5B (FIG. 5B is a continuation of FIG. 5A), collectively referred to as FIG. 5. The example deep learning model 500 of FIG. 5 incudes a multilayer 2-dimensional (2D) CNN (502 through 508), a bidirectional LSTM recurrent neural network 510, an attention network 520, and dense fully connected network layers 530, for processing the input video frames 501 to generate rheological estimates as outputs.

The example 2D CNN above may include, for example, time distributed 2D CNN 502, a normalization layer 504, a pooling layer 506, and a flattening layer 508, with example feature size and dimensions indicated in FIG. 5A. Example shape and dimensions for the LSTM network 510 and the attention network 520 are also indicated in FIG. 5A. Example architecture for the dense fully connected network 530 is illustrated in further detail in FIG. 5B.

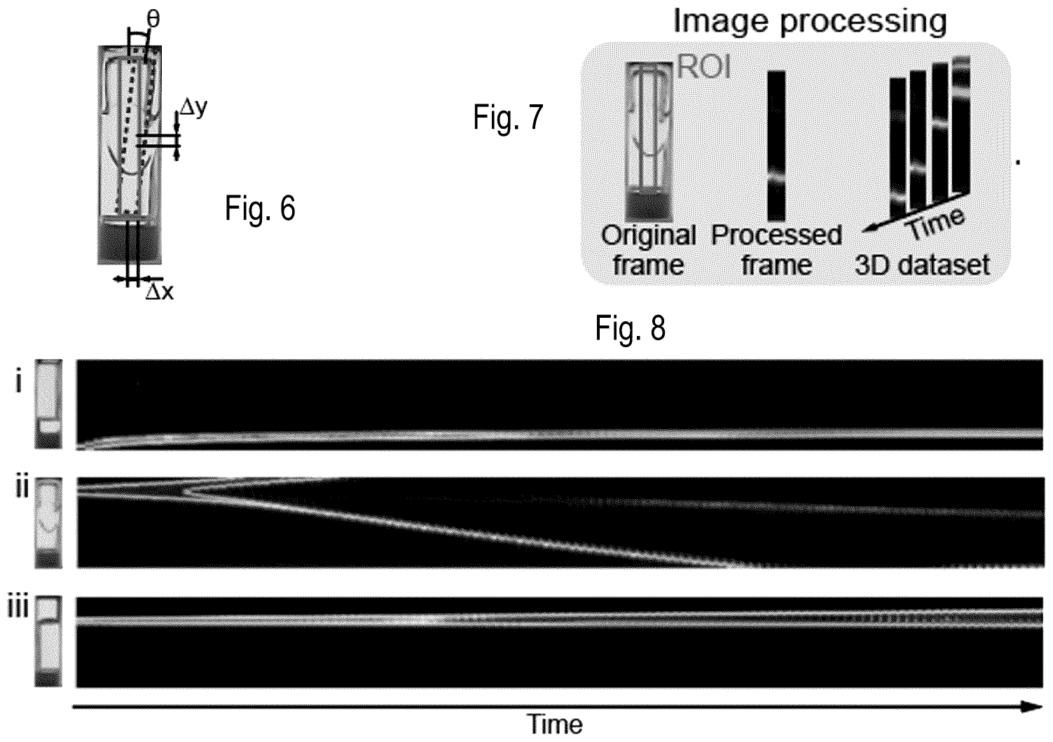

The example deep learning model above may be applied to the vial flip test of FIG. 1. FIG. 6 through FIG. 8 further illustrate preprocessing of input video images from such vial flip tests of example fluids. For example, in order to remove portions of the input video images that may not be helpful for the deep learning models to extract the rheological information, the input images may be spatially filtered to generate regions of interest (ROI) for processing by the deep learning model.

FIG. 6 shows an example process to spatially crop an input image frame of a tilted vial test to generate one or more ROI images. For example, an ROI may be obtained by applying a spatial mask with a predetermined shape and size to the original image frame. The spatial mask may be applied with a predetermined set of orientations to generate multiple ROIs from one input image frame, as shown by the solid and dashed masks in FIG. 6.

A sequence of preprocessed images after applying a particular spatial filter with a particular orientation to the input video image sequence is shown in FIG. 7. The sequence of preprocessed images forms a 3D data set with two spatial dimensions and a time dimension. FIG. 8 further shows three preprocessed image sequences corresponding to three different fluids with different viscosities. Besides spatial filtering for ROI, the preprocessing of the input images may further include, for example, Sobel gradient and Gaussian Blur to remove color.

Training the example deep learning model above may be performed using labeled images from experimental observation or computational simulation. Training of the model may be performed for a particular test so that the trained model may be used to process images taken from that particular test. Different models may be trained for different types of tests or different combinations of types of tests. Each of these models may have a same or different network architecture.

For example, to train a deep learning mode of FIG. 5 for processing images taken for tilted vial tests to generate viscosity estimate, videos for vial tilting test of a number of fluids with standard/know viscosity may be taken. For example, 15 different fluids with known viscosity at 6 different temperatures may undergo 10 vial tilting tests, yielding 900 (15×6×10) different videos for 90 different viscosities. For each video, as an example, 10 different ROIs of different portion and/or different orientation may be selected as illustrated in FIG. 6, where the offset of the center of the ROI from the center of the vial Δx, Δy and the orientation of the ROI θ take random values of 0-3 pixels, for Δx, Δy, and between 0-1 degree for θ. That results in a total of 9000 training videos (time sequences of images), each labeled with a viscosity and fluid density. Each video frame may be further processed using a Sobel gradient and a Gaussian Blur to remove its color. The preprocessed videos are then fed into the deep leaning model. The model may be trained via back propagation of loss and using gradient descent methods, such as using an Adams optimizer.

After the deep learning model is trained, it may then be used for estimating or predicting rheological properties (in the sample above, the viscosity of the fluid being tested). For example, the inputs to the deep-learning model may be the video sequence of the fluid under the test and its density. The deep-learning model would then process the input image and output an estimate for its viscosity, or output a predicted value range for the viscosity of the fluid. In some implementations, different orientation of ROI of the video images may be separately fed to the deep learning model and the resulting estimates of viscosity may be averaged to provide an averaged viscosity with a standard deviation.

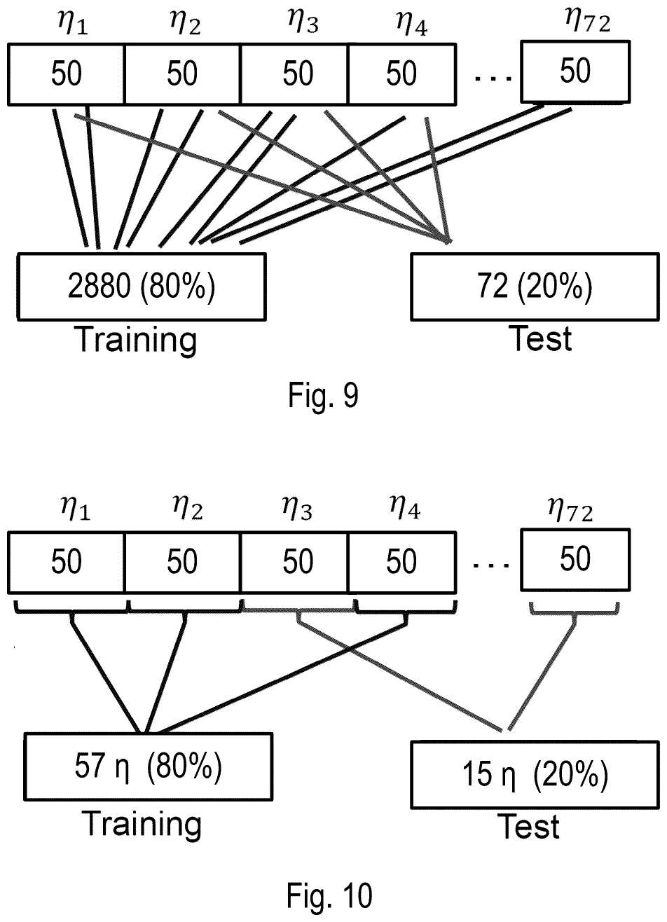

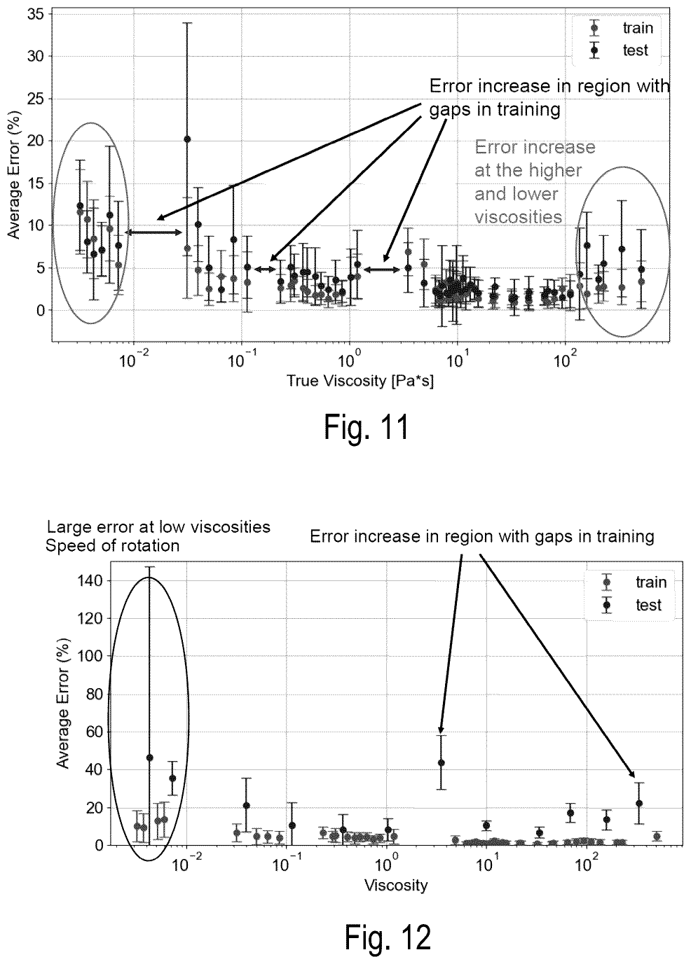

Several experiments were performed to evaluate the performance of the deep learning model and its training process above. For example, in one experiment, as shown in FIG. 9, the training of the deep learning model may be performed by randomly selecting 80% of all the labeled images for samples across all viscosities, whereas the evaluation for predictive performance of the model may be performed using the rest of the 20% of the labeled images, also across all viscosities. In another experiment, as shown in FIG. 10, the training of the deep learning model may be performed by randomly selecting 80% of all the labeled images for samples across a subset of viscosities, whereas the evaluation for predictive performance of the model may be performed using the rest of the 20% of the labeled images, across other viscosities that are not used for training. The evaluation results for these two different experiments of FIG. 9 and FIG. 10, are shown in FIG. 11 and FIG. 12, respectively. For example, FIG. 11 for the first experiment shows an average predictive error of under 10% in the range of viscosity from 0.01 to 400 Pa*s, except points in training gaps, which can be improved by adding training samples in these gap regions. For another example, FIG. 12 for the second experiment shows an average predictive error of under 20% in the range of viscosity from 0.01 to 400 Pa*s, except points in training gaps, which, again, can be improved by adding training samples in these gap regions.

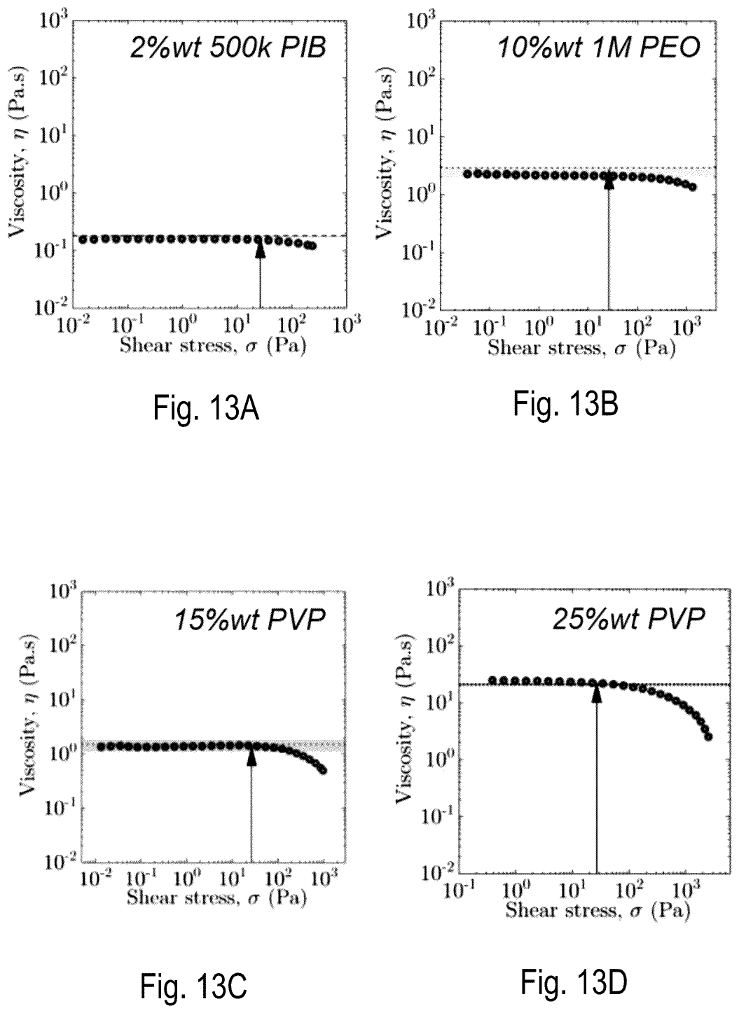

The example trained model for vial tilting testing is further used to estimate viscosity of several example non-Newtonian fluids, as shown in FIG. 13A through FIG. 13D (with the example fluid indicated in the figure). FIG. 13A through FIG. 13D show that the model estimates of the viscosity of the various fluids agree with the rheometer measurement at low shear stress, where the fluids behave in a Newtonian manner. The estimation begins to deviate from actual rheometer measurement at high shear stress as the model is trained using Newtonian fluids.

To summarize, this disclosure generally relates to rheological property measurements for fluidic materials and is specifically directed to methods and systems for automatic and high-throughput estimation of rheological properties via videography of visually observable tests and neural-network processing. Such high throughput may be achieved via parallel testing. The disclosed methods and systems provide an economical approach to estimate rheological properties with reasonable prediction accuracy based on visual observables without relying on expensive and complex rheometric setup and equipment.

It is to be understood that the various implementations above are not limited in their application to the details of construction and the arrangement of components set forth above and in the accompanying drawings. The disclosure is intended to cover other embodiments that may be practiced or carried out in various ways following the underlying principles disclosed herein.

It should also be noted that a plurality of hardware and software-based devices, as well as a plurality of different structural components may be used to implement the various embodiments of the disclosure. In addition, it should be understood that the example embodiments of this disclosure may include hardware, software, and electronic components or modules that, for purposes of discussion, may be illustrated and described as if the majority of the components are implemented solely in hardware. However, one of ordinary skill in the art, and based on a reading of this disclosure, would recognize that, in at least one embodiment, the electronic based aspects of the invention may be implemented in software (e.g., stored on non-transitory computer-readable medium) executable by one or more processors. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. These controllers may be implemented as dedicated processing circuitry or in general-purpose processors, in combination of various software and/or firmware, and in combination of other wired or wireless communication interfaces.

We claim:

1. A method for generating an estimate of at least one rheological property of a plurality of fluids or solid-state materials, comprising:
providing a plurality of carriers;
loading the plurality of fluids or solid-state materials into or on the plurality of carriers;
setting the plurality of fluids or solid-state materials in motions relative to the plurality of carriers so as to commence a plurality of visually observable rheological tests of the plurality of fluids or solid-state materials;
synchronously triggering a recording of digital videos of the plurality of visually observable rheological tests for the plurality of fluids or solid-state materials during the motions; and
automatically generating the estimate of the at least one rheological property for the plurality of fluids or solid-state materials by propagating the digital videos through a pretrained multilayer neural network model.

2. The method of claim 1, wherein the at least one rheological property comprises one or more of viscosity, yield stress, thixotropy, viscoelasticity, shear normal stress differences, and extensional viscosity.

3. The method of claim 1, wherein the plurality of visually observable rheological tests comprises one or more of: fluid motion following vial tilting (vial tilting test), viscous gravity current, falling ball viscometric test, capillary viscometric test, cup viscometric test slump test, maximum bubble test, viscous catenary test, inclined plane test, compression test, gravity extension test, bounce test, viscoelastic wave test, capillary breakup test, die swell test, and rod climbing test.

4. The method of claim 1, wherein the plurality of fluids or solid-state materials comprise at least two different fluids or solid-state materials and the visually observable rheological tests comprise a single type of rheological tests.

5. The method of claim 1, wherein the plurality of fluids or solid-state materials comprise a single type of fluids or solid-state materials and the visually observable rheological tests comprise at least two types of rheological tests.

6. The method of claim 1, wherein the plurality of fluids or solid-state materials comprise at least two types of fluids or solid-state materials and the visually observable rheological tests comprise at least two different rheological tests.

7. The method of claim 1, wherein:
the plurality of fluids or solid-state materials comprise at least two fluids of different composition;
each of the plurality of carriers comprises a vial;
the visually observable rheological tests comprise flip-vial tests; and
the at least one rheological property comprises viscosity.

8. The method of claim 1, where the pretrained multilayer neural network model comprises at least a 2-dimensional convolutional neural network, a bidirectional long-short-term memory recurrent neural network, and attention network layer.

9. The method of claim 1 where the plurality of fluids or solid-state materials possess a time varying behavior due to a physical or chemical reaction which changes the at least one rheological property of the fluids or solid-state materials at ambient conditions, and wherein the triggering of the recording of the digital video of the visually observable rheological tests and generating the estimate is repeated to capture the time varying behavior.

10. The method of claim 1 where the pretrained multi-layer neural network model gives an estimate of an expected variation of the at least one rheological property of the plurality of fluids or solid-state materials at durations longer than visually observable rheological tests.

11. The method of claim 1, wherein:
each of the digital videos is recorded to capture a visually observable test of one of the plurality of fluids or solid-state materials; and
the each of the digital videos is automatically pre-processed using a plurality of spatial masks with predefined boundaries and orientations functioning as region-of-interest filters to generate a plurality of filtered digital videos before being propagated through the pretrained multilayer neural network model to generate an average of the estimate of a rheological property for the one of the plurality of fluids or solid-state materials.

12. A system for generating an estimate of at least one rheological property of a plurality of fluids or solid-state materials, comprising:
a platform;
a plurality of testing stations configured on the platform for securing a plurality of carriers for loading the plurality of fluids or solid-state materials;
a plurality of driving mechanisms for setting the plurality of fluids or solid-state materials in motions relative to the plurality of carriers so as to commence a plurality of visually observable rheological tests of the plurality of fluids or solid-state materials;
a video camera; and
a controller configured to control the video camera to synchronously trigger a recording of digital videos of the plurality of visually observable rheological tests for the plurality of fluids or solid-state materials during the motions and to automatically generate the estimate of the at least one rheological property for the plurality of fluids or solid-state materials by propagating the digital videos through a pretrained multilayer neural network model.

13. The system of claim 12, wherein the at least one rheological property comprises one or more of viscosity, yield stress, thixotropy, viscoelasticity, shear normal stress differences, and extensional viscosity.

14. The system of claim 12, wherein the plurality of visually observable rheological tests comprises one or more of: fluid motion following vial tilting (vial tilting test), viscous gravity current, falling ball viscometric test, capillary viscometric test, cup viscometric test slump test, maximum bubble test, viscous catenary test, inclined plane test, compression test, gravity extension test, bounce test, viscoelastic wave test, capillary breakup test, die swell test, and rod climbing test.

15. The system of claim 12, wherein the plurality of fluids or solid-state materials comprise:
at least two different fluids or solid-state materials and the visually observable rheological tests comprise a single type of rheological tests; or
a single type of fluids or solid-state materials and the visually observable rheological tests comprise at least two types of rheological tests; or
at least two types of fluids or solid-state materials and the visually observable rheological tests comprise at least two different rheological tests.

16. The system of claim 12, wherein:
the plurality of fluids or solid-state materials comprise at least two fluids materials of different composition;
each of the plurality of carriers comprises a vial;
the visually observable rheological tests comprise flip-vial tests;
the at least one rheological property comprises viscosity; and
the plurality of driving mechanisms comprises a common stepper motor.

17. The system of claim 12, where the pretrained multilayer neural network model comprises at least a 2-dimensional convolutional neural network, a bidirectional long-short-term memory recurrent neural network, and attention network layer.

18. The system of claim 12, wherein:
each of the digital videos is recorded to capture a visually observable test of one of the plurality of fluids or solid-state materials; and
each of the digital videos is automatically pre-processed using a plurality of spatial masks with predefined boundaries and orientations functioning as region-of-interest filters to generate a plurality of filtered digital videos before being propagated through the pretrained multilayer neural network model to generate an average of the estimate of a rheological property for the one of the plurality of fluids or solid-state materials.

19. The method of claim 3, where the vial tilting test comprises a flip-vial test using cylindrical, spherical, triangular prism, or cuboid vial geometries.

20. The system of claim 14, where the vial tilting test comprises a flip-vial test using cylindrical, spherical, triangular prism, or cuboid vial geometries.
